(19) United States
(12) Patent Application Publication
(10) Pub. No.: US 2022/0284488 A1
(43) Pub. Date: Sep. 8, 2022

(54) DRIVE-THRU FACILITY

(71) Applicant: DEGO MALAYSIA SDN BHD, KUALA LUMPUR (MY)

(72) Inventor: Nabil Feisal BAMADHAJ, KUALA LUMPUR (MY)

(21) Appl. No.: 17/420,012

(22) PCT Filed: Mar. 18, 2021
(86) PCT No.: PCT/MY2021/050016

§ 371 Date: Jun. 30, 2021

(30) Foreign Application Priority Data
Feb. 25, 2021 (MY) PI2021001019

(51) Int. Cl. G06Q 30/06; G06Q 20/20

(52) U.S. Cl. CPC G06Q 30/0601; G06Q 20/20

(57) ABSTRACT

The present invention relates to a process for vehicle drive-thru facility (101) adapted to process order and payment, receive, store and deliver commercial and retail classified goods offered by a plurality of tenants, the process comprising the steps of: providing at least one ordering module at one entry point of the vehicle drive-thru facility (101) to receive or retrieve at least one drive-thru order (103) from at least one order list from at least one user using the vehicle drive-thru facility (101); placing at least one servicing station (102) side by side in a pair for each of the tenants, having a vehicle access road to each of the servicing station (102); placing at least one pick-up/drop-off station on each or one of the servicing station (102) to deliver the drive-thru order (103); and providing a drive-thru lane indication or direction once the goods relating to the drive-thru order (103) for the user is ready or served at the servicing station (102), wherein a pair of servicing station (102) positioned adjacent or opposing side to each of the tenants, such that the pick-up/drop-off station positioned for ease of the vehicle accessing the access road to each of the servicing station or assigned parking lot (102) to retrieve the goods.

### TECHNICAL FIELD

The present invention relates to a drive-thru facility, in particular, relates to a method and system for efficiently ordering and serving goods at the drive-thru facility.

### BACKGROUND OF THE INVENTION

Recently, vehicle drive-thru bays have become a necessity in recent years. Drive-thru bays are used by restaurants, laundries, banks, grocery stores and other businesses to provide improved service to the public.

Drive-thru bays typically accommodate one vehicle at a time and include either a single drive-thru or, in some cases, a first window to pay and a second window to pick up the goods. However, at certain times customers have to wait too long to order to complete and the cant get out of the line to obtain other goods or perform other task, while awaiting for their order to complete. For example, when only one vehicle can be waited on at a time, a waiting line forms, slowing down the service and causing an inconvenient wait.

These configurations exist, for example, in many fast food restaurant locations. There are distinct disadvantages with this approach.

The current vehicle drive-thru/drive-up structures typically provide single category goods, such as a single location for drive-thru prepared goods, and another location with a drive-thru/drive-up structures for drive-thru other fast food or restaurant, all locations which are limited in product or goods.

U.S. Pat. No. 5,595,263 to Pignataro describes a structure has vertical columns surrounding it and guiding robot carriages carrying robots, which can reach into the compartments, withdraw articles and place them onto a conveyor. This disclosure is deficient because there is a limitation on the number of vehicles that can be serviced from a single configuration. The order stations are situated in a way that allows only one car to order from each side from particular merchandising column divisions. However, this system still requires multiple stops for a consumer, which is not convenient.

A substantial disadvantage of the current system is that the customer required to drive to several locations that specialize in various items, and pays for the products separately at each drive-thru location and facility. In addition, the drive-thru customer required to wait for each order to be processed and filled and manually handed to the customer via drive-thru lane. Hence, there is a need for a system that able to cater multiple drive-thru facility in single location and reduce the waiting time of the customers.

### SUMMARY OF THE INVENTION

One embodiment of the present invention relates to a system for vehicle drive-thru facility adapted to process order and payment, receive, store and deliver commercial and retail classified goods offered by a plurality of tenants, comprising: at least one ordering module positioned at one entry point to process order and payment, receive or retrieve at least one drive-thru order from at least one order list from at least one user using the vehicle drive-thru facility; at least one servicing station positioned side by side in a pair for each of the tenants, having a vehicle access road to each of the servicing station; at least one pick-up/drop-off station positioned on each or one of the servicing station to deliver the drive-thru order, in which the user driving a user vehicle provided by a system a drive-thru lane indication or direction once the goods relating to the drive-thru order for the user is ready or served at the servicing station or assigned parking lot.

Preferably, the servicing station positioned adjacent or opposing side to each of the tenants, such that the pick-up/drop-off station positioned for ease of the vehicle accessing the access road to each of the servicing station or assigned parking lot to retrieve the goods.

Further, the system comprising a distribution module for distributing the drive-thru order for the user relating the servicing station based on order list.

Further, the system comprising a payment distribution module for distributing the drive-thru order payment for the user relating the servicing station or assigned parking lot based on order list.

Further, the system comprising a preparing module positioned at each the servicing station for tracking completion time of the drive-thru order for the user.

Further, the system comprising a display unit to provide the drive-thru lane indication or direction to the servicing station or assigned parking lot for the user.

Preferably, the ordering module positioned at the entry point of vehicle drive-thru facility comprising; a Digital Menu Board or interactive menu display; an intercom unit for the user communicating with at least one employee of the servicing station; and a communication unit to receive or retrieve the order and receive payment for the user.

Preferably, the vehicle drive-thru facility having at least one waiting area or parking lot for the vehicle accessing the drive-thru facility.

Preferably, the ordering module positioned at the entry point of vehicle drive-thru facility having an automated security barriers that communicate with the ordering module for providing access to the service station.

Further, the system comprising a mobile device connected via network to the system or the ordering module for accessing the order list of the vehicle drive-thru facility, in which the user performs the drive-thru order and payment remotely using the mobile device.

Preferably, the mobile device used by the user performs the drive-thru order is verified or authenticated at the ordering module or the pick-up station to retrieve the goods relating to the drive-thru order.

Preferably, the mobile device indicates at least one optimized route and pickup sequence locations at the drive-thru facility relating to the drive-thru order.

Preferably, the drive-thru order is verified or authenticated at the ordering module or the pick-up station by using QR code scanning, access card, Bluetooth, infrared, or RFID.

Preferably, the vehicle access road is arranged in continuous direction to each of the servicing station from the entry point of the vehicle drive-thru facility.

Another embodiment of the present invention relates to a process for vehicle drive-thru facility adapted to process order and payment, receive, store and deliver commercial and retail classified goods offered by a plurality of tenants, the process comprising the steps of: providing at least one ordering module at one entry point of the vehicle drive-thru facility to receive or retrieve at least one drive-thru order from at least one order list from at least one user using the vehicle drive-thru facility; placing at least one servicing station side by side in a pair for each of the tenants, having a vehicle access road to each of the servicing station; placing at least one pick-up station on each or one of the servicing station to deliver the drive-thru order; and providing a drive-thru lane indication or direction once the goods relating to the drive-thru order for the user is ready or served at the servicing station or assigned parking lot, wherein a pair of servicing station positioned adjacent or opposing side to each of the tenants, such that the pick-up station positioned for ease of the vehicle accessing the access road to each of the servicing station or assigned parking lot to retrieve the goods.

Preferably, the servicing station pair positioned in mirror images of each other and are interconnected by a common wall and a common access road.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF THE DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates a process for vehicle drive-thru facility adapted to receive, store and deliver commercial and retail classified goods offered by a plurality of tenants.

FIG. 2 illustrates a flow chart of system receiving customer order.

FIG. 3 illustrates one embodiment of the vehicle drive-thru facility arrangement or setup.

### DETAILED DESCRIPTION OF THE PREFERRED EMBODIMENTS

One embodiment of the present invention relates to a system for vehicle drive-thru facility adapted to process order and payment, receive, store and deliver commercial and retail classified goods offered by a plurality of tenants, comprising: at least one ordering module positioned at one entry point to receive or retrieve or process payment at least one drive-thru order from at least one order list from at least one user using the vehicle drive-thru facility; at least one servicing station positioned side by side in a pair for each of the tenants, having a vehicle access road to each of the servicing station; at least one pick-up/drop-off station positioned on each or one of the servicing station to deliver or receive the drive-thru order, in which the user driving a user vehicle provided by a system a drive-thru lane indication or direction once the goods relating to the drive-thru order for the user is ready or served at the servicing station or at the assigned parking lot.

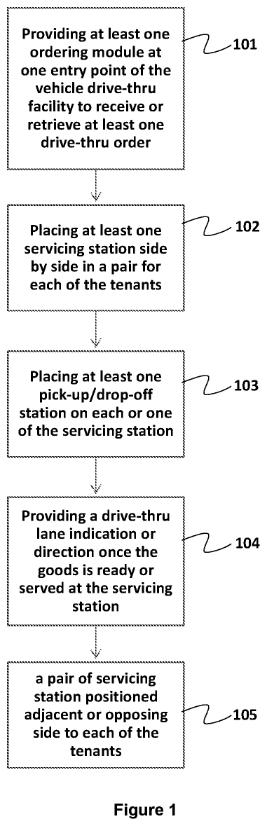

Another embodiment of the present invention relates to a process for vehicle drive-thru facility adapted to process order and payment, receive, store and deliver commercial and retail classified goods offered by a plurality of tenants, the process as illustrated in FIG. 1 comprising the steps of: providing at least one ordering module at one entry point of the vehicle drive-thru facility to process order and payment or receive or retrieve at least one drive-thru order and at least one payment from at least one order list from at least one user using the vehicle drive-thru facility (101), placing at least one servicing station side by side in a pair for each of the tenants, having a vehicle access road to each of the servicing station (102), placing at least one pick-up/drop-off station on each or one of the servicing station to deliver the drive-thru order and payment (103), and providing a drive-thru lane indication or direction once the goods relating to the drive-thru order for the user is ready or served at the servicing station or assigned parking lot (104), wherein a pair of servicing station positioned adjacent or opposing side to each of the tenants, such that the pick-up/drop-off station positioned for ease of the vehicle accessing the access road to each of the servicing station or assigned parking lot to retrieve the goods (105).

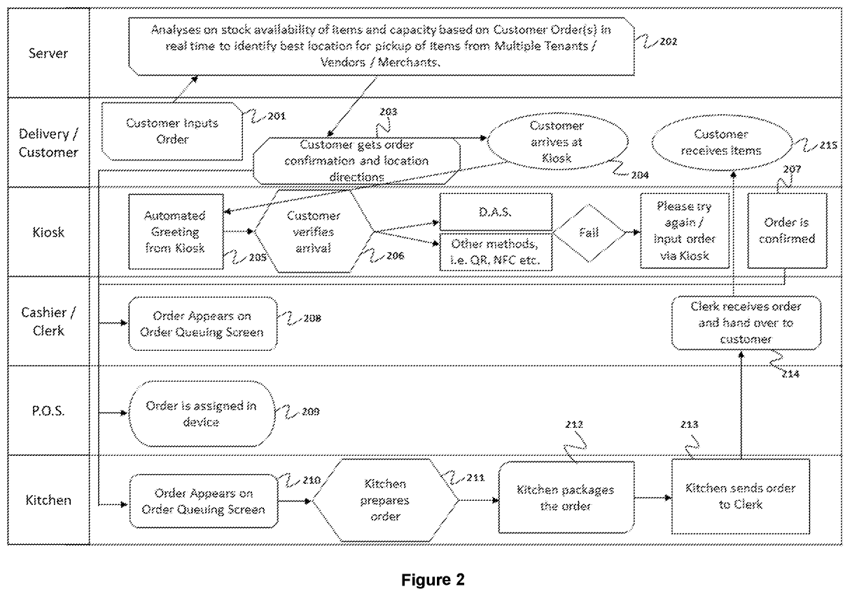

As illustrated in FIG. 2, the steps of a system receiving customer order comprising, at least one Customer Inputs Order or drive-thru order from at least one order list into the system, via ordering module positioned at one entry point (201), thereafter the system Analyses on stock availability of items and capacity based on Customer Order(s) in real time to identify best location or servicing station for pickup of Items from Multiple Tenants, Vendors, Merchants (202), Customer makes payment and gets order confirmation and location directions to the specified or selected facility (203). Thereafter Customer arrives at Kiosk or ordering module within the facility located at entry point (204), wherein the user will be greeted by a worker or automated machine at the Kiosk or ordering module (205), then the Customer verifies his arrival by providing order details or making an order or drive-thru order from at least one order list into the system (206), once the Payment and Order is confirmed (207) by the system, the drive-thru order Appears on Order Queuing Screen of the system located at the Cashier or clerk (208), and the user drive-thru order will be assigned or saved in at least one point ordering system (POS) for each tenant (209), then the related Order for each tenant will displayed on Order Queuing Screen in the kitchen (210), then the Kitchen staff prepares the relevant order (211), and the Kitchen staff packages the order (212). The Kitchen staff sends order to Clerk (213), in which the Clerk receives order and hand over to the relevant customer (214), then the Customer retrieve or receives the order Items (215) at each of the servicing station or assigned parking lot located within the facility.

Preferably, the system for vehicle drive-thru facility adapted to process order and payment, receive, store and deliver commercial and retail classified goods offered by a plurality of tenants, comprising: a pair of servicing station positioned adjacent or opposing side to each of the tenants, such that the pick-up/drop-off station positioned for ease of the vehicle accessing the access road to each of the servicing station or assigned parking lot to retrieve or receive or drop-off the goods.

Preferably, the system for vehicle drive-thru facility adapted to process order and payment, receive, store and deliver commercial and retail classified goods offered by a plurality of tenants, comprising: further comprising a distribution module for distributing the drive-thru order for the user relating the servicing station or assigned parking lot based on order list.

Preferably, the system for vehicle drive-thru facility adapted to process order and payment, receive, store and deliver commercial and retail classified goods offered by a plurality of tenants, comprising: further comprising a payment distribution module for distributing the drive-thru order payment for the user relating the servicing station based on order list.

Preferably, the system for vehicle drive-thru facility adapted to process order and payment, receive, store and deliver commercial and retail classified goods offered by a plurality of tenants, comprising: further comprising a preparation module positioned at each the servicing station or assigned parking lot for tracking completion time of the drive-thru order for the user.

Preferably, the system for vehicle drive-thru facility adapted to process order and payment, receive, store and deliver commercial and retail classified goods offered by a plurality of tenants, comprising: further comprising a display unit to provide the drive-thru lane indication or direction to the servicing station for the user.

Preferably, the system for vehicle drive-thru facility adapted to process order and payment, receive, store and deliver commercial and retail classified goods offered by a plurality of tenants, comprising: further comprising a plurality of illuminated lanes to provide direction or indication to the servicing station for the user.

Preferably, the system for vehicle drive-thru facility adapted to process order and payment, receive, store and deliver commercial and retail classified goods offered by a plurality of tenants, comprising: wherein the ordering unit positioned at the entry point of vehicle drive-thru facility comprising; a Digital Menu Board or interactive menu display; an intercom unit for the user communicating with at least one employee of the servicing station; and a communication unit to receive or retrieve the order for the user.

Preferably, the system for vehicle drive-thru facility adapted to process order and payment, receive, store and deliver commercial and retail classified goods offered by a plurality of tenants, comprising: wherein the vehicle drive-thru facility having at least one waiting area or parking lot for the vehicle accessing the drive-thru facility.

Preferably, the system for vehicle drive-thru facility adapted to process order and payment, receive, store and deliver commercial and retail classified goods offered by a plurality of tenants, comprising: wherein the ordering unit positioned at the entry point of vehicle drive-thru facility having an automated security barriers that communicate with the ordering module for providing access to the service station.

Preferably, the system for vehicle drive-thru facility adapted to process order and payment, receive, store and deliver commercial and retail classified goods offered by a plurality of tenants, comprising: further comprising a mobile device connected via network to the system or the ordering module for accessing the order list of the vehicle drive-thru facility, in which the user performs the drive-thru order and payment remotely using the mobile device.

Preferably, the mobile device used by the user performs the drive-thru order and payment is verified or authenticated at the ordering module or the pick-up/drop-off station or assigned parking lot to retrieve or receive the goods relating to the drive-thru order.

Preferably, the mobile device indicates at least one optimized route and pickup/drop-off sequence locations at the drive-thru facility relating to the drive-thru order.

Preferably, the drive-thru order is verified or authenticated at the ordering module or the pick-up/drop-off station by using QR code scanning, access card, Bluetooth, infrared, RFID, biometric recognition or Delivery Authentication System.

Preferably, the system for vehicle drive-thru facility adapted to process orders and payments, receive, store and deliver commercial and retail classified goods offered by a plurality of tenants, comprising: wherein the vehicle access road is arranged in continuous direction to each of the servicing station from the entry point of the vehicle drive-thru facility.

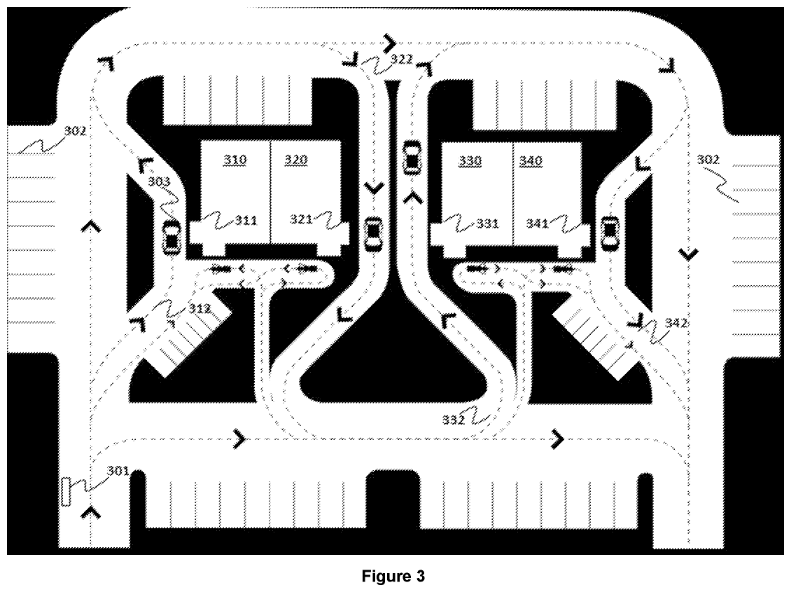

One embodiment of the present invention is illustrated in FIG. 3, where the vehicle drive-thru facility (300) adapted to process order and payment, receive, store and deliver commercial and retail classified goods offered by a plurality of tenants (310,320,330,340) positioned within the facility (300), comprising: at least one ordering module (301) positioned at one entry point or entrance of the facility, to process or receive or retrieve at least one drive-thru order from at least one order list from at least one user and process at least one payment using the vehicle drive-thru facility (300); at least one servicing station (311,321,331,341) positioned side by side in a pair for each of the tenants (310,320,330,340), or four servicing station (311,321,331,341) arranged in pairs. The vehicle drive-thru facility (300) a vehicle access road (312,322,332,342) to each of the servicing station (311,321,331,341); at least one pick-up/drop-off station positioned on each or one of the servicing station (311,321,331,341) to deliver or receive the drive-thru order, in which the user driving a user vehicle (303) provided by a system a drive-thru lane indication or direction once the goods relating to the drive-thru order for the user is ready or served at the servicing station (311,321,331,341).

The process for vehicle drive-thru facility (300) adapted to process order and payment, receive, store and deliver commercial and retail classified goods offered by a plurality of tenants (310,320,330,340), referring to FIG. 3 comprising the steps of: providing at least one ordering module (301) at one entry point of the vehicle drive-thru facility (300) to process or receive or retrieve at least one drive-thru order from at least one order list from at least one user and process at least one payment using the vehicle drive-thru facility (300), placing at least one servicing station (311,321,331,341) side by side in a pair for each of the tenants (310,320,330,340), having a vehicle access road (312,322,332,342) to each of the servicing station (311,321,331,341) (102), placing at least one pick-up/drop-off station on each or one of the servicing station (311,321,331,341) to deliver the drive-thru order, and providing a drive-thru lane indication or direction once the goods relating to the drive-thru order for the user is ready or served at the servicing station (311,321,331,341), wherein a pair of servicing station (311,321,331,341) positioned adjacent or opposing side to each of the tenants (310,320,330,340), such that the pick-up/drop-off station positioned for ease of the user vehicle (303) accessing the access road to each of the servicing station (311,321,331,341) to retrieve the goods.

Vehicle Drive-Thru Facility

Vehicle drive-thru facility is a place to accommodate multiple vendors to perform their sales and services. The vehicle drive-thru facility is made to process order and payment, receive, store and deliver commercial and retail classified goods offered by a plurality of tenants and distribute their order payment. Each of the facility positioned side by side in a pair for each of the tenants, wherein each of the unit has access to the vehicle access. The vehicle drive-thru facility may include full fledge kitchen setup, seating arrangements for walk-in customers, payment counters, pick-up or drop-off stations. The vehicle drive-thru facility incorporated with drive-thru ordering system, which can receive orders, updated orders, perform updates on stocks, list stocks, update or add commercial and retail classified goods that are provided by the tenant.

Tenants

The tenant positioned at each of the facility provides list of the commercial and retail classified goods for at least one user of the facility. Typically, each tenant with the same facility provides different category of commercial and retail classified goods or relating to fast food or food and beverages facility which are suitable for drive-thru facility. Each of the tenant required to use the system provided by facility which centralizes ordering system, and order that are relating to the tenant are transmitted to each of the tenant or kitchen to prepare the goods relating to the order made by at least one user. By using the vehicle drive-thru facility, tenant does not require to setup a system or a point-of-sales system, the tenant may use the readily assembled system within the vehicle drive-thru facility.

Classified Good

The commercial and retail classified goods offered by the tenants can be listed in the system for the user to choose and perform the order and payment at the facility or before arriving to the facility to collect their orders. By this way, the user able to perform order and payment from multiple tenant at single point or single order. The commercial and retail classified goods are updated based on the feedback from the tenant or kitchen. The commercial and retail classified goods are prepared or readily available within premises of the facility.

Ordering Module

The ordering module is one of the module in the system which is assembled or placed within the premises to retrieve order or taking order and payment from at least one of the user. The order is performed via a platform placed within the premises or at the entry point of the facility. The order and payment also can be performed via mobile phone or electronic devices that is connected to the ordering module of the system via a network. The ordering module has an interactive interface to perform the order and payment, the user able to select and navigate through the module to perform their selection. Each order may include from multiple tenant or multiple goods from multiple tenant within the drive-thru facility.

Drive-Thru Order

The ordering module positioned at one entry point to receive or retrieve at least one drive-thru order from at least one order list from at least one user using the vehicle drive-thru facility, where the drive-thru order is made based on the order list.

Order List

The order list is generated from at least one tenant using the vehicle drive-thru facility or via system positioned at the facility or at least one electronic devices used by the tenant.

Servicing Station

The Vehicle Access Road is build such that it has access to each of the Servicing Station within the facility.

Pick-Up/Drop-Off Station

The Pick-Up/Drop-Off Station is build such that it has access to each of the tenant within the facility.

Drive-Thru Lane Indication or Direction

The user driving a user vehicle provided by a system a drive-thru lane indication or direction once the goods relating to the drive-thru order for the user is ready or served at the servicing station or assigned parking lot. The drive-thru lane indication or direction is interactive lighting. The drive-thru lane indication or direction is made of a plurality of illuminated lanes or road lighting to provide direction or indication to the servicing station or assigned parking lot for the user.

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

Throughout this specification, unless the context requires otherwise, the word “comprise”, or variations such as “comprises” or “comprising”, will be understood to imply the inclusion of a stated step or element or integer or group of steps or elements or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

1. A system for vehicle drive-thru facility (101) adapted to process order and payment, receive, store and deliver commercial and retail classified goods offered by a plurality of tenants, comprising:
at least one ordering module positioned at one entry point to receive or retrieve at least one drive-thru order (103) from at least one order list from at least one user using the vehicle drive-thru facility (101);
at least one servicing station (102) positioned side by side in a pair for each of the tenants, having a vehicle access road to each of the servicing station (102);
at least one pick-up/drop-off station positioned on each or one of the servicing station (102) to deliver or receive the drive-thru order (103),
in which the user driving a user vehicle provided by a system a drive-thru lane indication or direction once the goods relating to the drive-thru order (103) for the user is ready or served at the servicing station or assigned parking lot (102).

2. The system for vehicle drive-thru facility (101) according to claim 1, wherein a pair of servicing station (102) positioned adjacent or opposing side to each of the tenants, such that the pick-up/drop-off station positioned for ease of the vehicle accessing the access road to each of the servicing station or assigned parking lot (102) to retrieve or receive the goods.

3. The system for vehicle drive-thru facility (101) according to claim 1, further comprising a distribution module for distributing the drive-thru order (103) for the user relating the servicing station (102) based on order list.

4. The system for vehicle drive-thru facility (101) according to claim 1, further comprising a payment distribution module for distributing the drive-thru order payment (103) for the user relating the servicing station (102) based on order list.

5. The system for vehicle drive-thru facility (101) according to claim 1, further comprising a preparation module positioned at each the servicing station (102) for tracking completion time of the drive-thru order (103) for the user.

6. The system for vehicle drive-thru facility (101) according to claim 1, further comprising a display unit to provide the drive-thru lane indication or direction to the servicing station or assigned parking lot (102) for the user.

7. The system for vehicle drive-thru facility (101) according to claim 1, further comprising a plurality of illuminated lanes to provide direction or indication to the servicing station or assigned parking lot (102) for the user.

8. The system for vehicle drive-thru facility (101) according to claim 1, wherein the ordering unit positioned at the entry point of vehicle drive-thru facility (101) comprising;
a Digital Menu Board or interactive menu display;
an intercom unit for the user communicating with at least one employee of the servicing station (102); and
a communication unit to receive or retrieve the order (103) for the user.

9. The system for vehicle drive-thru facility (101) according to claim 1, wherein the vehicle drive-thru facility (101) having at least one waiting area or parking lot for the vehicle accessing the drive-thru facility.

10. The system for vehicle drive-thru facility (101) according to claim 1, wherein the ordering unit positioned at the entry point of vehicle drive-thru facility (101) having an Automated security barriers that communicate with the ordering module for providing access to the service station.

11. The system for vehicle drive-thru facility (101) according to claim 1, further comprising a mobile device connected via network to the system or the ordering module for accessing the order list of the vehicle drive-thru facility (101), in which the user performs the drive-thru order (103) remotely using the mobile device.

12. The system for vehicle drive-thru facility (101) according to claim 9, wherein the mobile device used by the user performs the drive-thru order (103) is verified or authenticated at the ordering module or the pick-up/drop-off station to retrieve or receive the goods relating to the drive-thru order (103).

13. The system for vehicle drive-thru facility (101) according to claim 9, wherein the mobile device indicates at least one optimized route and pickup/drop-off sequence locations at the drive-thru facility relating to the drive-thru order (103).

14. The system for vehicle drive-thru facility (101) according to claim 9, wherein the drive-thru order (103) is verified or authenticated at the ordering module or the pick-up/drop-off station or assigned parking lot by using QR code scanning, access card, Bluetooth, infrared, RFID, biometric recognition or Delivery Authentication System.

15. The system for vehicle drive-thru facility (101) according to claim 1, wherein the vehicle access road is arranged in continuous direction to each of the servicing station or assigned parking lot (102) from the entry point of the vehicle drive-thru facility (101).

16. A process for vehicle drive-thru facility (101) adapted to process order and payment, receive, store and deliver commercial and retail classified goods offered by a plurality of tenants, the process comprising the steps of:
providing at least one ordering module at one entry point of the vehicle drive-thru facility (101) to receive or retrieve at least one drive-thru order (103) from at least one order list from at least one user using the vehicle drive-thru facility (101);
placing at least one servicing station (102) side by side in a pair for each of the tenants, having a vehicle access road to each of the servicing station (102);
placing at least one pick-up/drop-off station on each or one of the servicing station (102) to deliver the drive-thru order (103); and
providing a drive-thru lane indication or direction once the goods relating to the drive-thru order (103) for the user is ready or served at the servicing station (102),
wherein a pair of servicing station (102) positioned adjacent or opposing side to each of the tenants, such that the pick-up/drop-off station positioned for ease of the vehicle accessing the access road to each of the servicing station or assigned parking lot (102) to retrieve the goods.
